(19) United States
(12) Patent Application Publication
(10) Pub. No.: US 2020/0226763 A1
(43) Pub. Date: Jul. 16, 2020

(54) Object Detection Method and Computing System Thereof

(71) Applicant: Augentix Inc., Hsinchu City (TW)

(72) Inventor: Ku-Chu Wei, New Taipei City (TW)

(21) Appl. No.: 16/246,534

(22) Filed: Jan. 13, 2019

(51) Int. Cl. G06T 7/20

(52) U.S. Cl. CPC G06T 7/20; G06T 2207/10016

(57) ABSTRACT

An object detection method is disclosed. The method comprises receiving a current frame of a plurality of frames of a video; simultaneously tracking and detecting the current frame to determine an object list; and updating the object list for tracking at least an object of a following frame of the current frame.

### BACKGROUND OF THE INVENTION

### 1. Field of the Invention

The present invention relates to an object detection method and computing system thereof, and more particularly, to an object detection method and computing system capable of improving the object detection efficiency.

### 2. Description of the Prior Art

With the development of technology, all kinds of cameras and related devices are provided. The captured images or videos may be utilized for tracking objects, e.g. humans or vehicles. The object tracking procedure may be performed only when a detection result of a previous frame is given. In other words, object detection is necessary to determine objects in a frame previous to the current frame before tracking the objects on the captured images or videos. The object detection may be any kinds of detections, for example, face detection, vehicle detection or pedestrian detection.

For example, FIG. 1 is a timing diagram of a conventional technology of object detection and object tracking. As shown in FIG. 1, a video includes frames 0-15, which are sequentially generated by a capturing device, e.g. a digital camera. After the frame 0 is input, the object detection is performed to identify any new object in the frame 0. When one or multiple new objects are identified in the frame 0, the object tracking procedure is thereby performed on the frame 3. However, the object detection of the conventional technology takes longer time to determine any new object, e.g. longer than 1 frame time, which delays the object tracking procedure. Under this circumstance, an order of object detection and object tracking of the conventional technology is pre-defined and thereby decreases the efficiency, since the object tracking is based on the objects identified by the object detection. That is, the object tracking procedure can be performed only when the object detection procedure is finished.

Therefore, how to solve the problems mentioned above and efficiently detect and track objects in a video has become an important topic.

### SUMMARY OF THE INVENTION

It is therefore an object of the present invention to provide an object detection method and computing system thereof capable of increasing the object detection efficiency, so as to improve the disadvantages of the prior art.

An embodiment of the present invention discloses an object detection method, comprising receiving a current frame of a plurality of frames of a video; simultaneously tracking and detecting the current frame to determine an object list; and updating the object list for tracking at least an object of a following frame of the current frame.

An embodiment of the present invention further discloses a computer system, comprising a processing device; and a memory device coupled to the processing device, for storing a program code instructing the processing device to perform a process of image enhancement in a video, wherein the process comprises receiving a current frame of a plurality of frames of a video; simultaneously tracking and detecting the current frame to determine an object list; and updating the object list for tracking at least an object of a following frame of the current frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of a conventional technology of object detection and object tracking.

FIG. 2 is a schematic diagram of an object detection process according to an embodiment of the present invention.

FIG. 3 is a timing diagram of the object detection process according to an embodiment of the present invention.

FIGS. 4-6 are schematic diagrams of an implementation of the object detection process according to an embodiment of the present invention.

FIG. 7 is a schematic diagram of a computer system according to an example of the present invention.

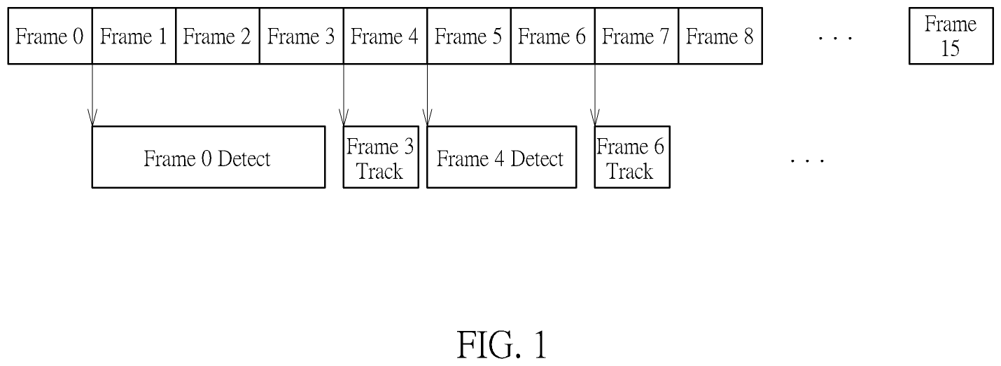

### DETAILED DESCRIPTION

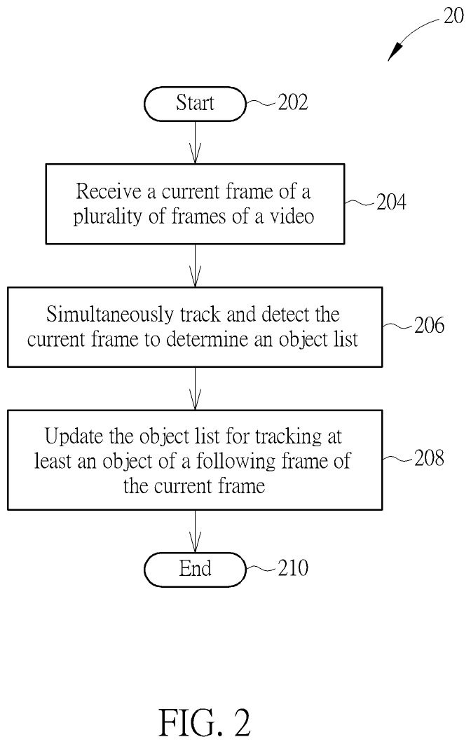

Please refer to FIG. 2, which is a schematic diagram of an object detection process 20 according to an embodiment of the present invention. The object detection method 20 of the present invention may be utilized on all kinds of detections, e.g. face detection, vehicle detection or pedestrian detection in images. The object detection process 20 includes the following steps:

Step 202: Start.

Step 204: Receive a current frame of a plurality of frames of a video.

Step 206: Simultaneously track and detect the current frame to determine an object list.

Step 208: Update the object list for tracking at least an object of a following frame of the current frame.

Step 210: End.

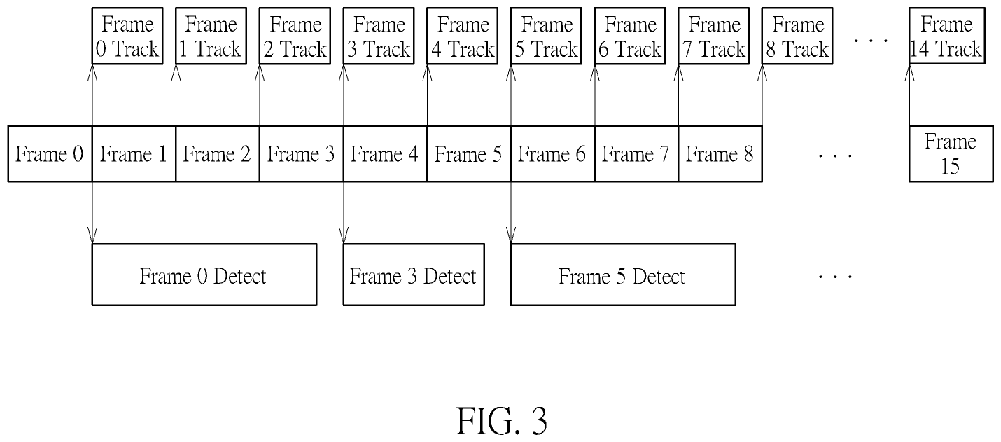

To explain the object detection process 20, please simultaneously refer to FIG. 3, which is a timing diagram of the object detection process 20 according to an embodiment of the present invention. As shown in FIG. 3, the video includes frames 0-15, which are sequentially generated by a capturing device, e.g. a digital camera, and the frames 0-15 are as an input in step 204 of the object detection process 20.

In step 206, the object detection and the object tracking are simultaneously performed on frame 0. When any new object is detected by the objection detection, the object list is updated and utilized for objection tracking. In an embodiment, since the object detection for frame 0 is not yet finished before frame 3, the object tracking for frames 0-2 are null until the object detection for frame 0 is finished. That is, the object tracking for frame 3 is performed based on a detection result of frame 0. Therefore, the object tracking for frames 4-15 may be performed based on the detection results accordingly. For example, the object tracking for frame 4 may be performed based on the detection result of frame 0. For another example, the object tracking for frame 5 may be performed based on the detection result of frame 3, since the latest frame detection is finished.

In step 208, the object list is updated for tracking one or multiple objects for a following frame. In other words, the object tracking may track the updated objects based on the updated object list generated from previous frames. In this way, the object detection and the object tracking of the present invention may be respectively and asynchronously performed on the frames. Therefore, the object detection process 20 is free from the pre-determined order, which limits the order of the object detection and the object tracking in the prior art, and thereby increases the efficiency of object detection.

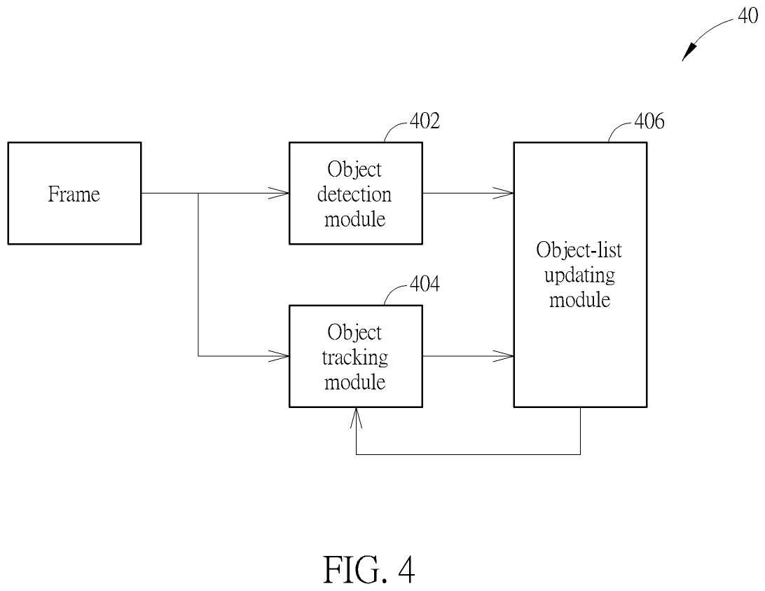

According to different applications and design concepts, the object detection process 20 of the present invention may be implemented using all kinds of methods. Please refer to FIG. 4, which is a schematic diagram of an implementation 40 of the object detection process 20 according to an embodiment of the present invention. The implementation 40 includes an object detection module 402, an object tracking module 404 and an object-list updating module 406. In this example, the object detection module 402 and the object tracking module 404 simultaneously receive the frames individually to generate the object list. In addition, the object-list updating module 406 evaluates the detection result generated by the object detection module 402 and a tracking result generated by the object tracking module 404 to determine the object list. Notably, the updated object list determined by the object-list updating module 406 may be further taken as a feedback to the object tracking module 404. For example, when the object tracking module 404 performs the object tracking on frame 3, the updated object list generated by the object-list updating module 406 for frame 0 may be utilized for tracking the objects on frame 3, such that the accuracy and efficiency of the tracking result are increased.

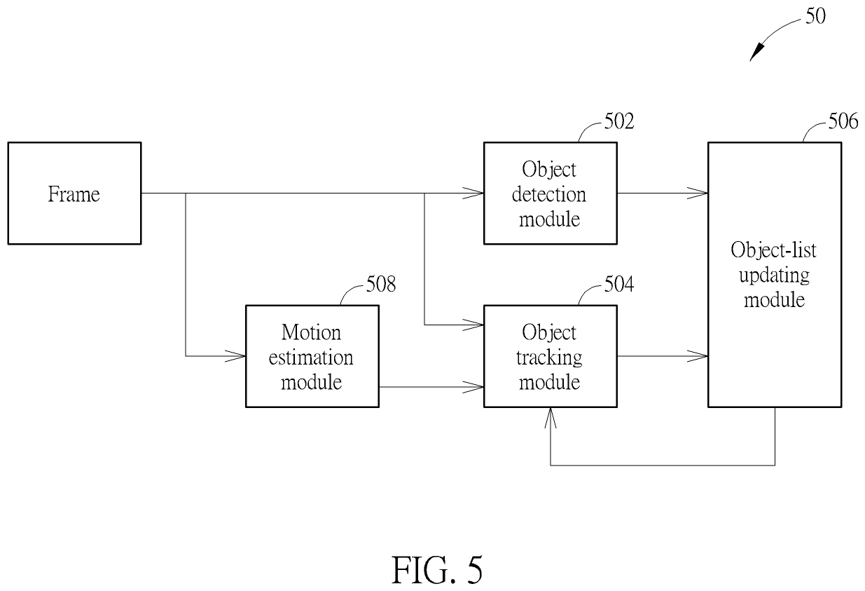

In another embodiment, please refer to FIG. 5, which is a schematic diagram of an implementation 50 of the object detection process 20 according to an embodiment of the present invention. The implementation 50 includes an object detection module 502, an object tracking module 504, an object-list updating module 506 and a motion estimation module 508. Notably, different with the implementation 40, the implementation 50 further includes the motion estimation module 508 utilized for generating a dense motion vector field of the current frame. In detail, the motion estimation module 508 may be implemented by a video encoder to generate the dense motion vector field of the current frame, which represents a motion relationship between the current frame and the previous frames. In an example, when the object tracking module 504 tracks frame 5, the motion estimation module 508 generates the dense motion vector field of frame 4 and frame 5, such that the accuracy and efficiency of the object tracking module 504 is improved. In another embodiment, an average of inner motion vector of an object may be determined by the motion estimation module 508, and the average of the inner motion vector of the object may be taken as a velocity of the object. In this way, the dense motion vector field of previous frame may be utilized for tracking the object in the current frame. For example, the average of the inner motion vector of the object generated at frame 4 may be utilized for tracking the object in frame 5. Notably, the dense motion vector field may be generated according to more than two or more previous frames and not limited thereto. For example, the frame 4 and frame 5 may be utilized for determining the motion vector field to track the object in frame 6, but not limited thereto.

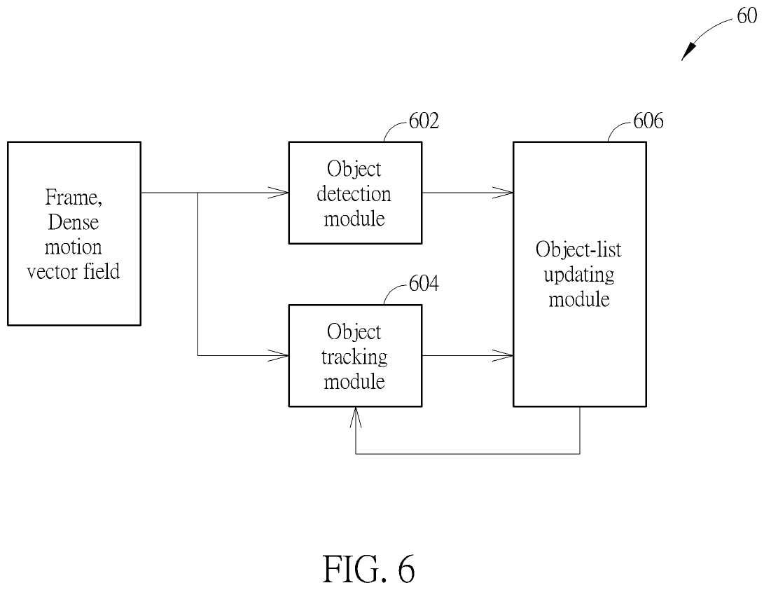

Refer to FIG. 6, which is a schematic diagram of an implementation 60 of the object detection process 20 according to an embodiment of the present invention. The implementation 60 includes an object detection module 602, an object tracking module 604 and an object-list updating module 606. Different with the implementations 40 and 50, both of the object detection module 602 and the object tracking module 604 receive the frame and the dense motion vector field. In this way, the object detection module 602 may detect objects for the current frame based on the generated dense motion vector field, and further, the object tracking module 604 may track objects for the current frame, so as to improve the accuracy and efficiency of the object detection process 20. In addition, the dense motion vector field may be determined according to the inner motion vector of the object.

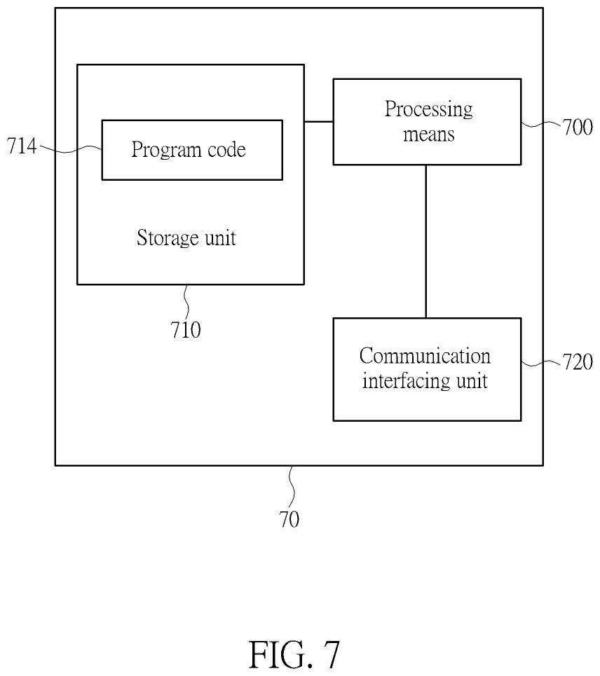

Moreover, please refer to FIG. 7, which is a schematic diagram of a computer system 70 according to an example of the present invention. The computer system 70 may include a processing means 700 such as a microprocessor or Application Specific Integrated Circuit (ASIC), a storage unit 710 and a communication interfacing unit 720. The storage unit 710 may be any data storage device that can store a program code 714, accessed and executed by the processing means 700. Examples of the storage unit 710 include but are not limited to a subscriber identity module (SIM), read-only memory (ROM), flash memory, random-access memory (RAM), CD-ROM/DVD-ROM, magnetic tape, hard disk and optical data storage device.

Notably, the embodiments stated above illustrates the concept of the present invention, those skilled in the art may make proper modifications accordingly, and not limited thereto. For example, the dense motion vector field may be derived by decoding the video or the modules of implementations 40, 50 and 60 may be implemented by other devices, software or circuitries, and not limited to the modules stated above. In addition, the object detection method of the present invention might be utilized for all kinds of detections, e.g., face detection, vehicle detection or pedestrian detection in images.

In summary, the object detection method and the computer system of the present invention asynchronously track and detect objects in the frames, and thereby improving the efficiency and accuracy of the object detection for videos.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object detection method, comprising:
receiving a current frame of a plurality of frames of a video;
simultaneously tracking and detecting the current frame to determine an object list; and
updating the object list for tracking at least an object of a following frame of the current frame.

2. The object detection method of claim 1, further comprising:
determining a dense motion vector field of the current frame before simultaneously tracking and detecting the current frame to determine the object list.

3. The object detection method of claim 2, wherein the dense motion vector field is derived by decoding the video.

4. The object detection method of claim 2, wherein the dense motion vector field is generated by a motion estimation module.

5. The object detection method of claim 1, further comprising tracking and detecting the current frame of the plurality of frames to determine the object list according to the dense motion vector field.

6. A computer system, comprising:
a processing device; and
a memory device coupled to the processing device, for storing a program code instructing the processing device to perform a process of image enhancement in a video, wherein the process comprises:
receiving a current frame of a plurality of frames of a video;
simultaneously tracking and detecting the current frame to determine an object list; and
updating the object list for tracking at least an object of a following frame of the current frame.

7. The computer system of claim 6, wherein the process comprises determining a dense motion vector field of the current frame before simultaneously tracking and detecting the current frame to determine the object list.

8. The computer system of claim 7, wherein the dense motion vector field is derived by decoding the video.

9. The computer system of claim 7, wherein the dense motion vector field is generated by a motion estimation module.

10. The computer system of claim 6, wherein the process comprises tracking and detecting the current frame of the plurality of frames to determine the object list according to the dense motion vector field.
